(19) United States
(12) Patent Application Publication
(10) Pub. No.: US 2011/0293492 A1
(43) Pub. Date: Dec. 1, 2011

(54) IN SITU PROCESS AND METHOD FOR GROUND WATER REMEDIATION AND RECOVERY OF MINERALS AND HYDROCARBONS

(76) Inventors: Douglas C. Gustafson, Antiouch, CA (US); Dana Wregglesworth, Wittmann, AZ (US)

(21) Appl. No.: 12/988,800

(22) PCT Filed: Apr. 14, 2009
(86) PCT No.: PCT/US09/02351

§ 371 Date: Aug. 17, 2011

Related U.S. Application Data
(60) Provisional application No. 61/044,892, filed on Apr. 14, 2008.
(60) Provisional application No. 61/118,128, filed on Nov. 26, 2008.

(51) Int. Cl. C22B 3/04; C02F 1/78; C02F 1/74; E21B 43/22; E21B 43/24; C01G 3/00; C01G 49/00; C01G 7/00; C01G 5/00; C01F 7/00; C02F 1/72; C01G 56/00; C02F 103/06

(52) U.S. Cl. 423/3; 210/747.8; 210/170.07; 166/307; 423/1; 423/27; 423/150.1; 423/131

(57) ABSTRACT

Devices, systems, and methods relating to advanced, high pressure oxidation are described. The devices, systems, and methods can be used to decontaminate ground water in a well or opening in a ground water table, and to recover minerals and hydrocarbons from subterranean deposits.

### CROSS-REFERENCE TO RELATED APPLICATIONS

This application claims priority to U.S. Provisional Application No. 61/044,892, filed on Apr. 14, 2008, and to U.S. Provisional Application No. 61/118,128, filed on Nov. 26, 2008, the entire disclosures of which are incorporated herein by reference.

### TECHNICAL FIELD

The present devices, systems, and methods relate to in situ, high pressure oxidation to decontaminate ground water through a well or other opening in a ground water table, and to recover valuable materials from depots in situ.

### BACKGROUND

Conventional “pump and treat” methods of water treatment to remove water born contaminants in ground water are performed at a remote site in a water treatment facility, or use on-site, above-ground water treatment systems. In either case, the contaminated ground water must be pumped from a water table to the treatment equipment, and then discharged as treated water. While such treatment methods are capable of producing potable water from water pumped from a contaminated ground water source, they do nothing to reduce the levels of contamination in the water that remains in the table.

One efficient technology that may be used to decontaminate water in such water treatment facilities is a high pressure, advanced oxidation process, known by the trademark HIPOX®, that utilizes ozone and hydrogen peroxide to form hydroxyl radicals. Reference herein to an “advanced, high pressure oxidation process” intends a process involving a gaseous oxidant (such as ozone, oxygen-enriched air, or oxygen) and a liquid oxidant (such as hydrogen peroxide), where one or both of the oxidants are introduced into water at a pressure above atmospheric pressure. The hydroxyl radicals that are formed are aggressive oxidants that convert contaminants into innocuous byproducts without generating a waste stream. High pressure oxidation is far less expensive than traditional treatment technologies, even for some recalcitrant contaminants. Unlike previous advanced oxidation methods, high pressure oxidation minimizes the formation of byproducts such as bromate, making it ideal for drinking water applications, as well as remediation and clean-up.

Despite advances for treating contaminated water above ground and under ideal conditions in a remote reactor, treating ground water in situ continues to involve exposing water in the water table to chemical oxidizing agents (oxidants), such as hydrogen peroxide (H₂O₂). Delivering the amount of oxidants adequate to decontaminate the ground water beneath involves locally applying high concentrations of the oxidants to the surface, which can cause unwanted reactions, including mineral and metal (e.g., iron) precipitation. A high concentration of oxidants at the surface may also react violently with organic components in the soil.

Therefore a need exists for improved methods for efficiently and inexpensively decontaminating ground water in situ, while avoiding unwanted site reactions in the water and soil.

### Mining and Drilling Operations

Conventional methods for recovering valuable materials from subterranean deposits involve open-pit mining, sub-surface mining, or drilling, depending on the type of deposit. The mining of metal ores is typically accomplished by open-pit or sub-surface mining, although in-situ leaching has been used to recover some materials, including uranium.

Petroleum (hydrocarbon) deposits, including crude oil and natural gas, are accessed by drilling. In some cases, petroleum deposits exist under sufficient hydrostatic pressure to facilitate recovery without the need to force the petroleum material to the surface. In other cases, water, steam, or other liquids are used to displace and force petroleum products to the surface. At some point, the cost of recovering the depots exceed their market value, resulting in the abandonment of only partially exhausted petroleum reservoirs.

Therefore a need exists for improved methods for efficiently and inexpensively recovering minerals and petroleum products in situ, while avoiding unwanted contamination of the sub-surface strata.

### SUMMARY

The following aspects and embodiments thereof described and illustrated below are meant to be exemplary and illustrative, not limiting in scope.

In one aspect, a method for decontaminating ground water in a water table is provided. The method comprises providing an opening at ground level above the level of water in the water table, the opening having walls and a bottom (or floor) below the level of water in the water table. An oxidant is introduced at a level below the level of contaminated water in the water table and, in one embodiment, a gaseous oxidant and a liquid oxidant are introduced. The oxidant(s) reduce the levels of contaminants in the water and surrounding soil to a predetermined or desired level.

In some embodiments, the gas oxidant is introduced into a reactor placed within the opening, the reactor having an influent port for receiving contaminated water and an effluent port for discharging water having reduced levels of contaminants. In some embodiments, the reactor represents a single point of delivery for the gas oxidant in the well or opening. In another embodiment, the opening for introduction of the oxidant(s) is an opening in the ground, such as a bore or hole, drilled or dug to a desired depth and having a desired diameter, and the ground soil or earth serves as the walls and floor of the opening to form the “reactor”.

In some embodiments, the liquid oxidant is introduced into the reactor. In some embodiments, the reactor represents a single point of delivery for the gas oxidant and the liquid oxidant in the well or opening.

In some embodiments, contaminated water is supplied to the influent port by means of a pump. In particular embodiments, the pump is positioned in the well or opening. In particular embodiments, the pump device is positioned above ground.

In some embodiments, effluent water reduced in contaminants is discharged from the effluent port back into the same well or opening. In some embodiments, effluent water reduced in contaminants is discharged from the effluent port into a second well or opening. In some embodiments, effluent water reduced in contaminants is discharged above ground.

In some embodiments, contaminated water is supplied to the influent port by means of gas rise caused by the rise of ozone, oxygen, or air introduced to the reactor.

In some embodiments, effluent water reduced in contaminants is discharged from the effluent port back into the same well or opening.

In some embodiments, the liquid oxidant is added directly to the well or opening peripherally with respect to the reactor. In some embodiments, the liquid oxidant is added in combination with the gas oxidant.

In some embodiments, the gas oxidant is delivered in pulses to the top of the reactor, which is adapted to allow the passage of the gas oxidant into the reactor. In some embodiments, the gas oxidant is delivered in pulses to the top of the reactor, which is adapted to allow the passage of the gas oxidant into the reactor while preventing the passage of the liquid oxidant into the reactor. In some embodiments, gas rise is produced when the pressure of the gas oxidant is reduced during said pulsing.

In some embodiments, the gas and liquid oxidants are introduced directly into the well or opening.

In some embodiments, the gas oxidant comprises ozone. In some embodiments, the liquid oxidant comprises hydrogen peroxide.

In another aspect, an in situ high pressure oxidation system for decontaminating ground water in a water table is provided. The system comprises a high pressure oxidation device adapted for placement in a well or opening having walls and a bottom below the level of water in the water table. The device has an influent port at a level below the level of water in the water table, an effluent port, and means for providing contaminated ground water to the influent port of the device and for providing one or more oxidants selected from the group consisting of ozone, oxygen, and hydrogen peroxide to the device for contacting contaminated water. In one embodiment, at least one oxidant is a gas. In another embodiment, the high pressure oxidation device constitutes a single or sole point of delivery of the at least one gas oxidant.

In some embodiments, the effluent port is at a level above the level of the influent port. In some embodiments, the effluent port is at a level below the influent port.

In some embodiments, the means for providing contaminated ground water to the influent port is a pump. In some embodiments, the means for providing contaminated ground water to the influent port is gas rise caused by the introduction of the at least one gas oxidant into the reactor.

In another aspect, a direct in situ high pressure oxidation system for decontaminating ground water in a water table is provided. The system comprises a well or opening having walls and a bottom below the level of water in the water table; a supply line and plurality of injectors, positioned below the level of water in the well or opening, for introducing to the contaminated water at least one gas oxidant, a supply line and plurality of injectors, positioned below the level of water in the well or opening, for introducing to the contaminated water hydrogen peroxide; wherein the at least one gas oxidant and hydrogen peroxide are introduced to water in the well or opening in the absence of a reactor, and wherein flow of contaminated water in the well or opening is produced by gas rise resulting from the introduction of the at least one gas oxidant.

In another aspect, a direct in situ high-pressure oxidation system for decontaminating ground water in a water table is provided. The system comprises a plurality of bore holes in the soil adjacent or in contact with a water table, the bore holes in a preferred embodiment positioned around or approximately around an outer diameter of a designated treatment area. A series of conduits for delivering at least one gas oxidant is provided, each conduit having at least one filter comprising a slotted grating arranged in line with said conduit and having a diameter less than the diameter of said conduit, wherein when each conduit is position in each of the plurality of bore holes each filter is positioned below the level of water in the water table, and each filter functions as a point of egress for the at least one gas oxidant into the soil of the water table, thereby reducing the levels of contaminants in the water of the water table.

In some embodiments, the system does not require a preexisting well or opening in the water table. In some embodiments, each filter is positioned at the bottom of each conduit, and each filter includes a pointed end for penetrating the soil.

In another aspect, a business method is provided. The business comprises remediating contaminated ground water in a water table in situ for a client using a method and/or system described herein, and charging the client a fee basing on the value of the remediated water.

In another aspect, a method for recovering minerals from a subterranean deposit is provided. The method comprises providing a well or opening (also referred to as a bore holed) having an opening at ground level above the level of the deposit, the well or opening having walls and a bottom below the level of at least a portion of the deposit; where the subterranean deposit is not in a water table. The method additionally comprises introducing water into the well or opening; introducing into the well or opening a liquid oxidant and a gas oxidant selected from the group consisting of ozone, oxygen, and air, wherein the gas and liquid oxidants produce a zone of influence around the well or opening within which dissolved mineral ions are leached from the deposits; recovering water enriched with dissolved mineral ions from the well or opening, thereby recovering minerals from the subterranean deposit.

In some embodiments, introducing a liquid oxidant and a gas oxidant is performed using a reactor placed in the well or opening.

In some embodiments, the mineral is uranium. In some embodiments, the mineral is selected from the group consisting of copper, iron, gold, solver, and aluminum.

In some embodiments, the mineral deposit is in a water table. In some embodiments, the mineral deposit is in soil or rock.

In another aspect, a business method is provided, comprising: recovering a mineral for a client using a method as described, and charging the client a fee basing on the value of the recovered mineral.

In another aspect, a method for recovering minerals from a subterranean deposit is provided. The method comprises forming a heap pile of material mined from a subterranean deposit; providing a well or opening in the heap pile; introducing into the well or opening a liquid oxidant and a gas oxidant selected from the group consisting of ozone, oxygen, and air, wherein the gas and liquid oxidants leach dissolved mineral ions from the heap pile; recovering oxidants enriched with dissolved mineral ions from the heap pile, thereby recovering minerals from the subterranean deposit.

In some embodiments, the mineral is uranium. In some embodiments, the mineral is selected from the group consisting of copper, iron, gold, solver, and aluminum.

In another aspect, a business method is provided, comprising: recovering a mineral for a client using a method as described, and charging the client a fee basing on the value of the recovered mineral.

In another aspect, a method for recovering hydrocarbons from a subterranean deposit is provided, comprising: providing a well or opening having an opening at ground level above the level of the deposit, the well or opening having walls and a bottom in fluid or gas communication with the deposit; introducing into the well or opening a liquid oxidant and a gas oxidant selected from the group consisting of ozone, oxygen, and air, wherein the gas and liquid oxidants stimulate release of the hydrocarbon from the deposit; recovering hydrocarbons from the well or opening, thereby recovering hydrocarbons from the subterranean deposit.

Some embodiments further comprise introducing water or steam into the well or opening.

In some embodiments, the hydrocarbon is crude oil. In some embodiments, the hydrocarbon is natural gas.

In another aspect, a business method is provided, comprising, recovering a hydrocarbon for a client using a method as described, and charging the client a fee basing on the value of the recovered hydrocarbon.

In addition to the exemplary aspects and embodiments described above, further aspects and embodiments will become apparent by reference to the drawings and by study of the following descriptions.

### BRIEF DESCRIPTION OF THE DRAWINGS

FIGS. 1A-1B are diagrams of a pump type in situ oxidation system.

FIGS. 2A-2B are diagrams of gas lift type in situ oxidation systems.

FIGS. 2C-2I show features of exemplary reactors for use in such systems.

FIGS. 3A-3B are diagrams of different in situ oxidation reactor systems that use a plurality of reactors.

FIGS. 4A-4F show features relating to a slotted grating filter to prevent the influx of soil and other particulates into the treatment apparatus.

FIG. 5 is a diagram of a direct in situ oxidation system.

FIG. 6 is a diagram of a different direct in situ high pressure, advanced oxidation system.

FIG. 7 is a diagram of an ozone and hydrogen peroxide injection configuration for use in a direct in situ high pressure, advanced oxidation system.

FIG. 8A-8B are diagrams showing configurations for site remediation.

FIG. 9 is a diagram of a direct in situ high pressure, advanced oxidation system for mineral recovery.

FIG. 10 is a diagram of a direct in situ oxidation system for hydrocarbon recovery.

FIG. 11 chart illustrating the history of ground water contamination at a site beginning approximately two years prior to installation of two in situ reactors.

### DETAILED DESCRIPTION

The present devices, systems, and methods relate to oxidation of water borne contaminants in situ, using advanced, high pressure oxidation, and to the use of high pressure, advanced oxidation to recover mineral and hydrocarbon deposits. The systems can be installed and the methods can be performed in a contaminated water table or mineral/hydrocarbon deposit site, avoiding the need to transport the contaminated water or mineral/hydrocarbon materials to a remote location, as in the case of conventional “pump and treat” systems and methods for mining and drilling operations.

### I. In Situ Oxidation

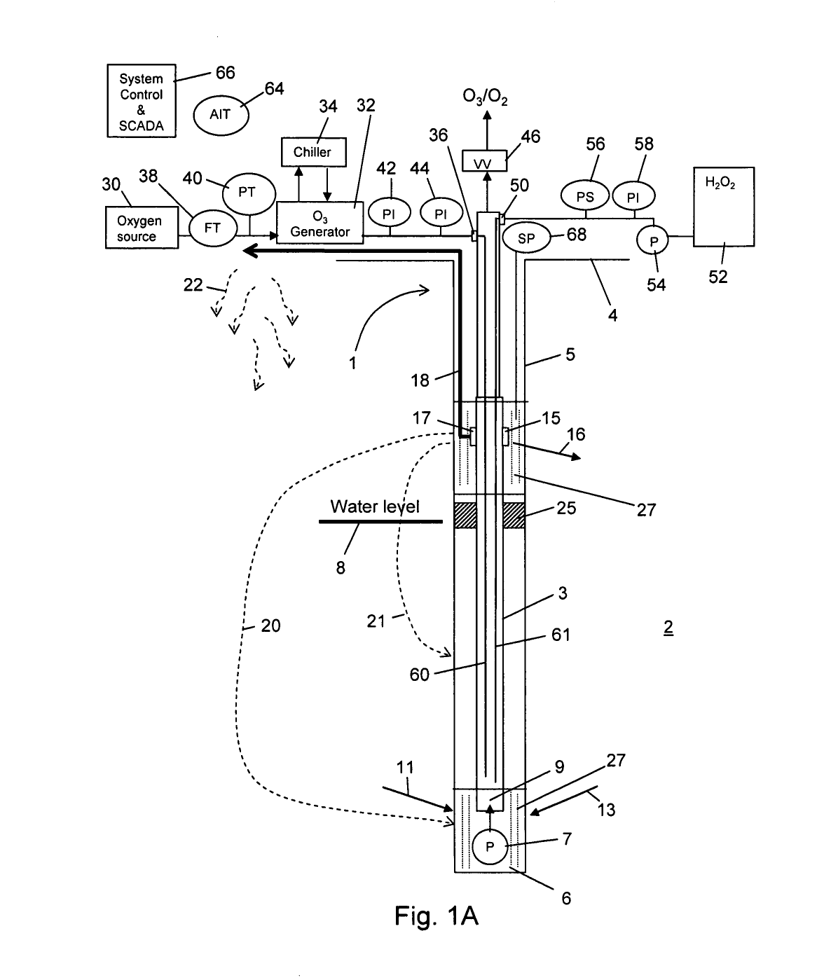

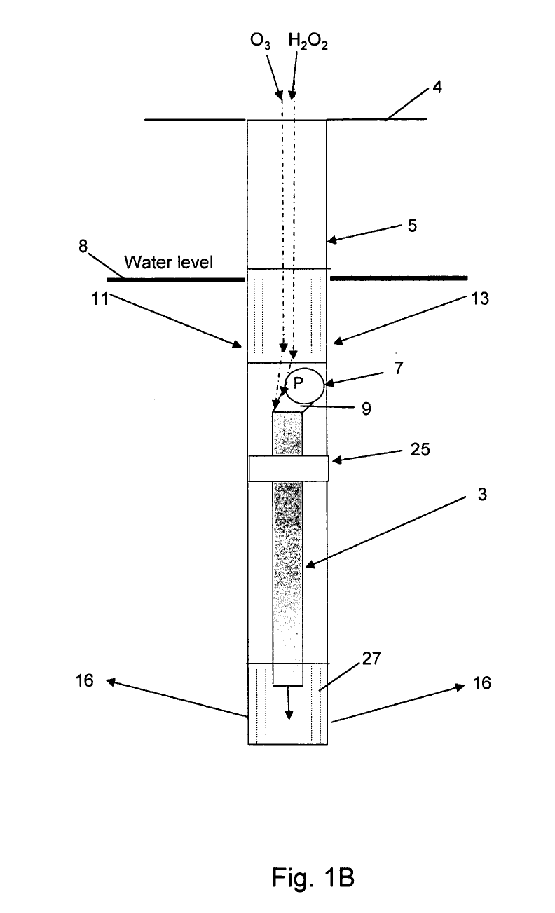

The devices, systems, and methods are described with reference to the accompanying drawings. A first embodiment of the in situ oxidation system is shown in FIGS. 1A-1B. System 1 includes at least one oxidation device or reactor 3 that provides a single point of delivery for gas and/or liquid oxidants in a well or other suitable opening 5 that provides access to contaminated water in a water table 2 (FIG. 1). The gas and/or liquid oxidants supplied can be transported upward (FIG. 1A) or downward (FIG. 1B) into opening 5. Opening or well 5 may be a monitoring well, a commercial or residential drinking water well, a crevice or crack, a earthen bore hole, or other opening in the ground that provides access to the water below ground. Operation of reactor 3 produces a zone of influence that destroys contaminants in and around well 5.

A. Pump Type System

In a “pump type” in situ oxidation system 1, a pump 7 is used to supply contaminated ground water from opening or well 5 to influent port 9 of reactor 3. Pump 7 may be positioned below reactor 3 (FIG. 1A), above reactor 3 (FIG. 1B), at essentially the depth as the top of the reactor, or above ground, i.e., on the surface 4. Where sufficient space is available, pump 7 may be positioned beside reactor 3. Pump 7 may rest on the bottom 6 of the well or opening 5 (FIG. 1A), rest above reactor 3 (FIG. 1B), or be suspended below reactor 3 (as described in more detail, below); therefore, the depth of the well or opening 5 is not critical to the installation or operation of the pump type system 1.

Referring to FIG. 1A, as illustrated by the solid lines with arrows 11, 13, contaminated influent water enters reactor 3 from well 5 below water level 8. Effluent water reduced in contaminants and including oxidants added to the water in reactor 3 may be discharged at a higher level, e.g., above water level 8, or even above ground level 4, through any number of effluent ports 15, 17. For example, effluent water can be discharged through into the same well or opening 5 (as illustrated by effluent port 15 and solid arrow 16), discharged through an effluent port 17 onto the ground above the well or opening 5 (as illustrated by the effluent port 17 and solid arrow 18), discharged into a different well or opening (not shown), discharged to a remote treatment facility for further processing, discharged for irrigation or other water uses, or any combination or variation thereof. The number and location of the effluent ports 15, 17 are exemplary. Note that the term “effluent port” refers broadly to an opening and associated conduit (if any) that permits the egress of water and/or oxidants from reactor 3.

When effluent water is discharged into the same well or opening 5, at least a portion of the water may eventually return to influent port 9 of reactor 3, having washed through the surrounding soil as indicated by the dashed lines with arrows 20, 21. Effluent water discharged onto ground surface 4 above the well or opening has the opportunity to wash more soil before returning to the well, as indicated by the several dashed lines with arrows 22.

With reference to FIG. 1B, another embodiment of an in situ oxidation is illustrated. In this embodiment, a system 1 wherein contaminated water flows in a downward (with respect to the ground surface) direction is shown. As illustrated by arrows 11, 13, contaminated influent water is transported into reactor 3 from well 5 below water level 8 and above a water transporting means, such as pump 7. Effluent water (shown by solid arrows 16) reduced in contaminant level and including oxidants added to the water (to the extent any oxidant remains unreacted with contaminants) is discharged at a level below reactor 3. It will be appreciated that this downward direction of water flow in the in situ system is particularly useful in applications where contaminant concentration has a vertical gradient, with a higher contaminant concentration near the ground surface 4 and a lower contaminant concentration near the bottom or floor of well 5.

With continuing reference to both FIGS. 1A-1B, one or more packing materials 25 may be used to divide the well or opening 5 into sections and/or prevent effluent water from immediately returning to the influent port 9 for short-cycling through reactor 3. In this manner, the reactor is continuously supplied with “fresh” contaminated influent water. Packer 25 is shown at water level but the one or more packers 25 may be positioned above, below, or at water level, depending on their intended function.

The one or more packers 25 can be made from a variety of materials, including but not limited to clay, gravel, sand, cement, asphalt, and rubber. Exemplary sealing compositions include bentonite. Expandable polymers such urethane can also be used to form the packers 25, as well as silicone compositions. Preferred materials do not further contaminate the ground water in the well or opening 5. In some embodiments, more than one material is used to form the one or more packers 25.

Any number of packers 25 can be used to form or improve a seal, stabilize reactor 3, or create discrete compartments within the well or opening 5 by serving as bulkheads. Independent of the packer 25, the well or opening 5 may optionally be fitted with one or more cages, scaffolds, or screens 27, which may attach to the wall of the opening 5, and provide structural support(s) and mounting point(s) for the advanced, high pressure oxidation device 1, as well as supporting equipment and hardware, such as the pump 7.

FIG. 1A additionally shows peripheral features of the in situ system 1, some of which improve function and operation. Such features include an oxygen source 30 and an ozone generator 32 (and associated chiller 34) for producing and cooling ozone for delivery to reactor 3 through at least one ozone port (and associated conduits) 36. The system 1 may also include a flow transmitter (FT) 38, pressure transmitter (PT) 40, and a pressure indicator (PI) 42, 44 for monitoring the supply of ozone to reactor 3.

Another feature is a suitable supply of a liquid oxidant 52 (which typically includes hydrogen peroxide (H₂O₂)) for delivering the liquid oxidant to the hydrogen peroxide port 50 of reactor 3 by means of a pump 54 (or by gravity feed). An optional pressure switch (PS) 56 and pressure indicator (PI) 58 are illustrated. The diagram shows internal conduits 60, 61 routing ozone from the ozone port 36 and hydrogen peroxide from the hydrogen peroxide port 50 to the bottom 6 of reactor 3; however, various reactor 3 configurations are contemplated, some of which are to be described.

Excess ozone, oxygen, or air can be released from the system 1 by means of a vent valve (VV) 46. System 1 may further include an analytic indicator transmitter (AIT) 64, and system control, optionally including a supervisory control/calculation and data acquisition (SCADA) unit 66, in operable communication (connections not shown in FIG. 1A) with the components of system 1 to facilitate monitoring and control. A sampling port (SP) 68 may provided to allow samples of the water in the well or opening 5 to be collected for analysis.

B. Gas Lift System

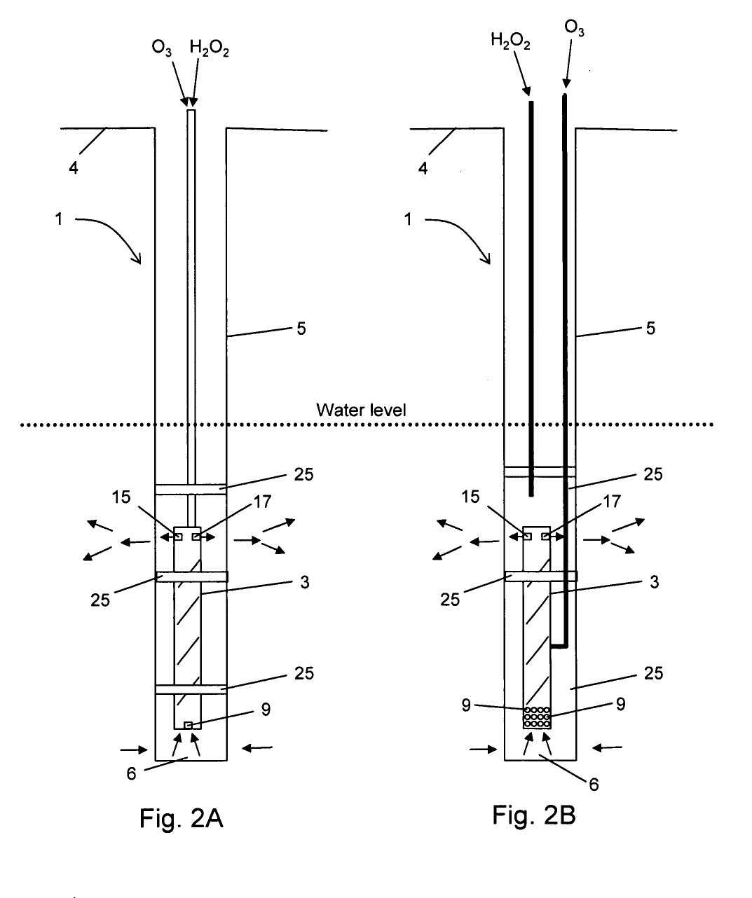

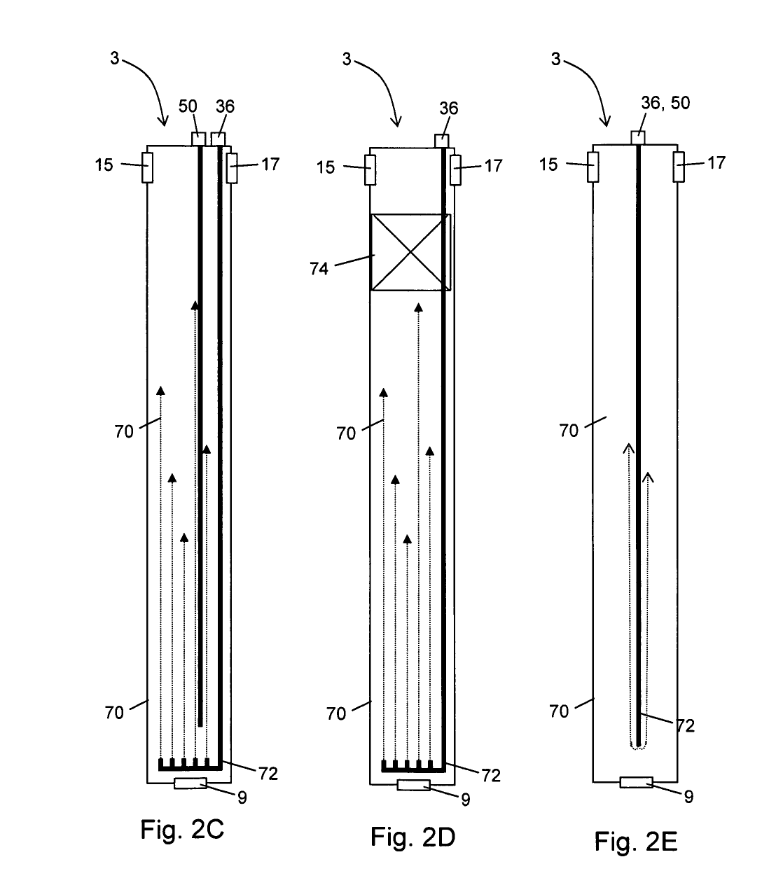

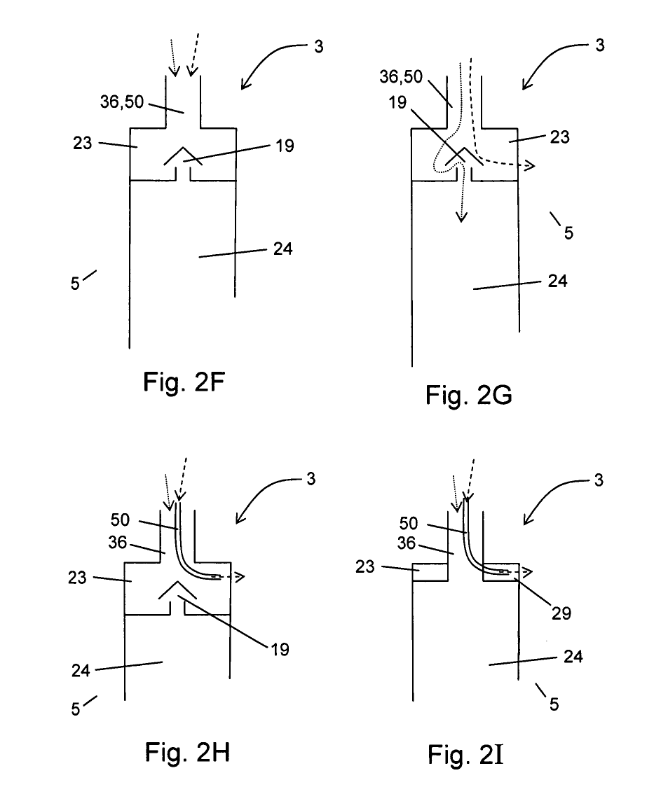

FIGS. 2A-2E illustrate various configurations of the in situ oxidation system 1 that utilize gas lift to induce ground water to flow through reactor 3. As shown in FIGS. 2A and 2B, reactor 3 may be installed in a well or similar opening 5 with contaminated ground water entering influent port(s) 9 of reactor 3 from the bottom 6 of well 5. Effluent water and oxidants are discharged from effluent ports 15, 17 into well 5 or opening (as illustrated). As above, one or more packers 25 may be used to prevent short cycling of the effluent back to the influent port 9. Well 5 may have a bottom 6 or may be of such a depth as to effectively bottomless. The surface level 4 and water level (dashed line) are indicated in the diagram for reference.

In the embodiment illustrated in FIG. 2A, both a gaseous (e.g., ozone, oxygen, or air) and a liquid (e.g., hydrogen peroxide) oxidant are delivered to reactor 3, which serves as a single point of delivery for the oxidants. In the embodiment illustrated in FIG. 2B, only gas oxidants are delivered to reactor 3, while liquid oxidants are delivered peripherally into the soil or water table. In this case, reactor 3 serves as a single point of delivery for gas oxidants, and liquid oxidants are delivered by a means physically separate from the reactor.

FIGS. 2C-2E show features of isolated gas rise reactor 3, as may be used in the systems 1 shown FIGS. 2A and 2B. These features include an influent port 9, effluent ports 15, 17 and an ozone port 36. Reactor 3 shown in FIG. 2B has a plurality of influent ports 9, while reactor 3 shown in FIG. 2A has a single influent port 9. This feature of reactor 3 is not critical.

A gas oxidant port 36 and a distribution conduit 72 may be used to conduct the gas oxidant to a preselected location in reactor 3, such as a particular level with respect to the height of reactor 3, a particular level with respect to the water level, the center or periphery of the inside of reactor 3, an oxidant distribution network inside reactor 3, and the like. Reactor 3 in FIG. 2C (and FIG. 2A) further includes a hydrogen peroxide port 50 for delivering hydrogen peroxide to reactor 3, while reactor 3 in FIG. 2D lacks a hydrogen peroxide port. In the latter case, hydrogen peroxide can be delivered peripherally with respect to reactor 3, as shown in FIG. 2B. Reactor 3 in FIG. 2E (and FIG. 2B) includes a single gas oxidant (or combined gas/liquid oxidant) port 36, 50 and minimal distribution conduit 72, which may be a tube having an exit positioned at a preselected level or location in reactor 3.

As illustrated by FIGS. 2C-2E, gas lift is a bulk flow process produced by the rise of injected gas (e.g., ozone, oxygen, or air) in reactor 3. The dotted lines with arrows 70 in FIGS. 2C-2E indicate the upward movement of ozone/air bubbles following gas oxidant injection, which produces upward flow in reactor 3. Even water below the level of the gas bubbles is subject to being drawn upward; therefore, gas lift can be achieved by injecting ozone or air into any part of reactor 3. Nonetheless, injecting the oxidant gas into the bottom of reactor 3, e.g., via a distribution tube 72, or injecting gas at several levels in reactor 3, is preferred for maximum efficiency (FIG. 2E).

A liquid oxidant, such as hydrogen peroxide may be injected toward the bottom of reactor 3 (FIG. 2C) or at multiple levels in reactor 3, such that both gas and/or liquid oxidizing agents are available to water immediately upon entering the influent port 9. Alternatively or additionally, a liquid oxidant may also be delivered peripherally with respect to reactor 3, as shown in FIG. 2B.

Note that reactor 3 in FIG. 2D further includes an optional mixer 74, which may be included in any of the configuration described, herein. Suitable examples of mixers include, but are not limited to, vane-type static mixers tab-type static mixers, and the like.

C. Delivery of Oxidants to the Top of the Reactor

FIGS. 2F and 2G show features of an upper portion 23 of reactor 3, which may be used in some embodiments of the systems and methods, particularly gas lift embodiments. The upper portion 23 of reactor 3 includes a common gas/liquid oxidant port 36, 50 and a valve 19 for directing the flow of oxidants. Valve 19 is similar to those used in distillation apparatuses but is oriented in the reverse orientation. As shown in FIG. 2G, gas oxidants can enter a main portion 24 of reactor 3 by passing through the valve 19 (dotted line), while liquid oxidants are deflected away from the main portion 24 of reactor 3 by the valve 19 (dashed line), thereby flowing into well 5 from the upper portion 23 of reactor 3, e.g., through the effluent port (not shown). Using this arrangement, gas lift is produced by delivering the gas oxidant into reactor 3 in pulses, wherein the gas oxidant is forced down into reactor 3 under pressure, then rises in reactor 3 to produce gas rise when gas pressure is reduced. In some embodiments, such pulsing of the gas oxidant is alternated with pulsing of the liquid oxidant.

FIG. 2H shows an embodiment of the upper portion 23 of reactor 3 similar to that in FIGS. 2F and 2G but which utilizes a coaxial configuration in which a liquid oxidant port 50 is contained within a gas oxidant port 36. As above, the liquid oxidant is directed away from the main portion of reactor 3 by a valve 19, while the gas oxidant is allowed to enter the main portion of reactor 3. FIG. 2I shows an embodiment using a coaxial configuration with respect to the gas oxidant port 36 and liquid oxidant port 50 but lacking valve 19. Instead, the liquid oxidant is delivered to a separate portion or compartment 29 within reactor 3, from which it may flow into the well (no shown).

Relying on gas lift to induce water to flow through the reactor avoids the complexity and expense of installing and operating a pumping system, which makes the in situ decontamination system and method more cost effective and less maintenance and installation intensive. Accordingly, some embodiment of the present apparatuses and methods rely on gas lift to cause contaminated water to flow through the reactor, and expressly do not require the use of a pump or the process of pumping to induce the flow of contaminated water.

D. Systems and Apparatuses Using a Plurality of Reactors

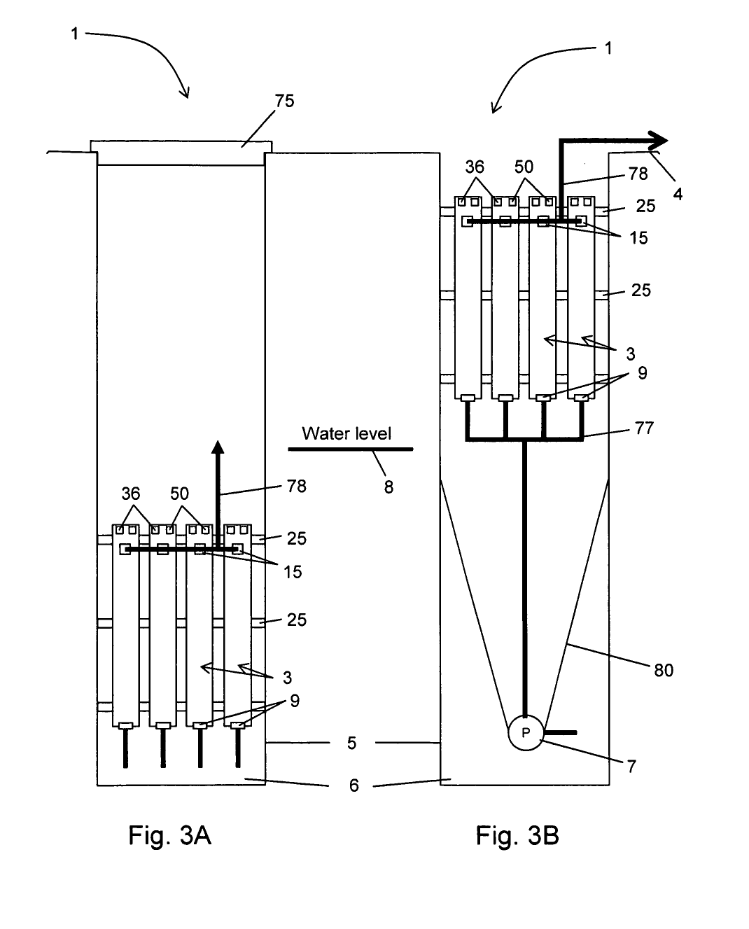

While the previous drawings have illustrated single reactor configurations, FIGS. 3A and 3B illustrate in situ oxidation systems 1 that include a plurality of reactors 3 positioned in the same well or opening 5. Depending on the embodiment, the plurality of reactors 3 may be placed above, below, or at the water level 8. In various embodiment, the plurality of reactors includes 2, 3, 4, 5, 6, or more individual reactors.

System 1 in FIG. 3A is a gas rise system, with the plurality of reactors 3 being positioned toward the bottom 6 of the well or opening 5. Each individual reactor in the plurality of reactors 3 may independently include features described above with respect to FIGS. 2A-2E

The system 1 in FIG. 3B is a pump-type system positioned near the surface of the well or opening 5 and above the water level 8, although it could be placed at or below the water level 8. The pump 7 may be suspended from tethers 80 attached to the wall of the well or opening 5, e.g., using a scaffold 27 (as shown in FIG. 1), e.g., positioned on the bottom 6 of the well or opening 5, or positioned above ground 4.

The systems 1 shown in FIGS. 3A-3B include optional packers 25. The system in FIG. 3A further includes a cap 75 to maintain a high level of ozone in the air above the ground water. The cap 75 may be fitted with a one way valve to allow excess ozone (or other gas) to escape. The cap may be fitted to any embodiment of the apparatuses and systems, including those involving one reactor or a plurality of reactors.

Where a plurality of reactors are used, one or more influent ports 9 of physically separate, individual reactors may be in communication with a common passage or manifold 77 (FIG. 3B) or may remain separate (FIG. 3A). Similarly, one or more effluent ports 15 of each reactor may be in communication with a common passage or manifold 78 (as shown) or may remain separate. In this illustration, the system 1 in FIG. 3A discharges decontaminated water into the same well 5, while the system 1 in FIG. 3B decontaminated water above ground 4. Ozone ports 36 and hydrogen peroxide ports 50 are indicated but other details are omitted.

Where a plurality of reactors 3 are placed in the same well or opening 5, the individual reactors may be arranged in parallel to increase the volume of decontaminated water that can flow through the system 1, or in series, to increase the efficiency of decontamination in a given volume of water. Moreover, each reactor in the plurality can be identically equipped and provided with the same amounts of oxidants, or treated as an independent reactor.

In all of the configurations illustrated and described, gas rise reactors should generally be placed in a substantially vertical orientation with the influent port below the effluent port. However, pump-type reactors can be placed in any orientation, including vertical and horizontal. Thus, while orienting the effluent port of toward the surface of the well or opening may be advantages in term of installation, it is not strictly necessary in the case of pump type systems. In addition, while all the illustrated systems involve an oxidation reactor placed in the well or opening, substantially or completely below the surface (i.e., subsurface), some configurations of the system can be used in an above-ground configuration, although some of the advantageous features may be lost.

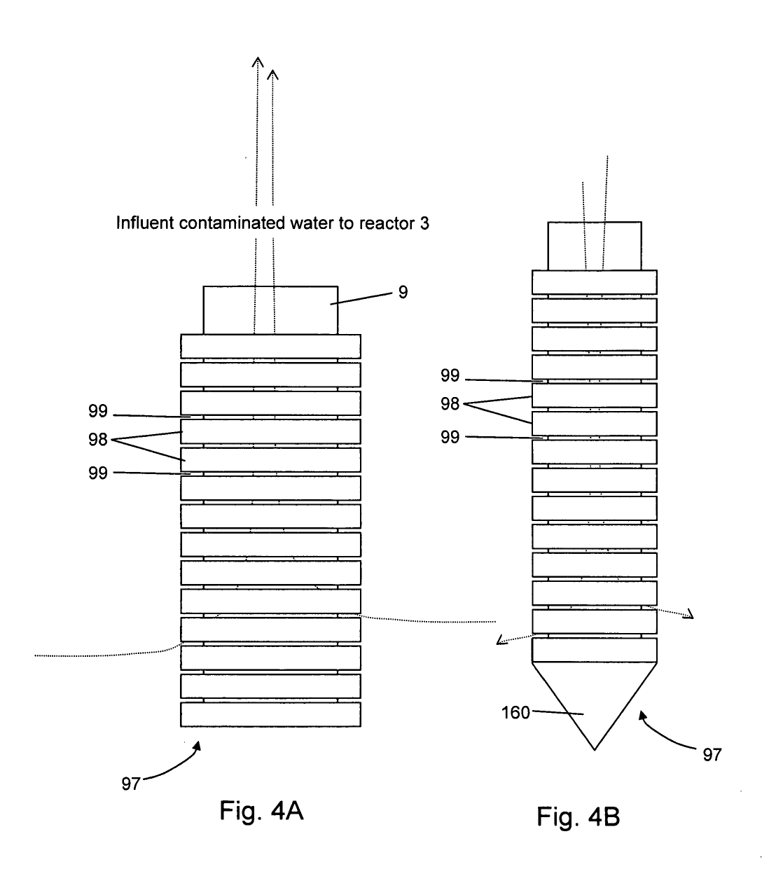

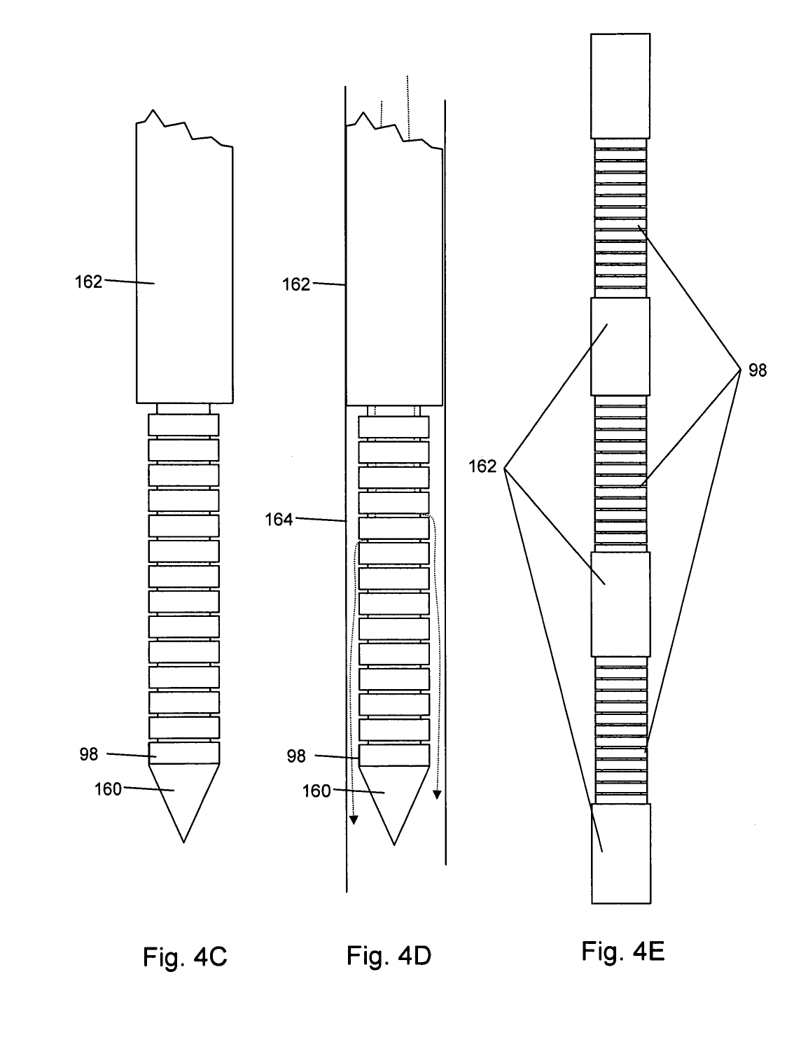

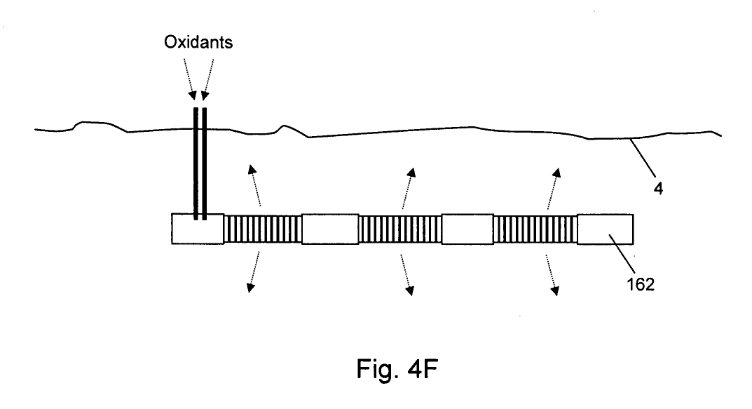

The influent port 9 of the reactor is preferably in communication with a filter 97 (FIGS. 4A-4B) designed to minimize the influx of soil and other particulate matter into reactor 3. One embodiment of the filter 97 utilizes a slotted grating 98 which defines openings 99 for allowing the passage of water (FIG. 4A). The dotted line indicates the direction of flow of influent water through the grating 98 toward the reactor (not shown). The openings 99 may be tailored to restrict particulate matter expected to be encountered in the particular well or opening 5. Exemplary sizes for the openings 99 are 1 mm, 0.5 mm, 0.3 mm, 0.1 mm, 0.05 mm, 0.03 mm, 0.01 mm, 0.005 mm, 0.003 mm, 0.001 mm, 0.0005 mm, 0.0003 mm, 0.0001 mm, 0.00005 mm, 0.00003 mm, 0.00001 mm, 0.000005 mm, and smaller. Further advantages and uses of the slotted grating 98 are discussed below.

### II. Direct In Situ Oxidation

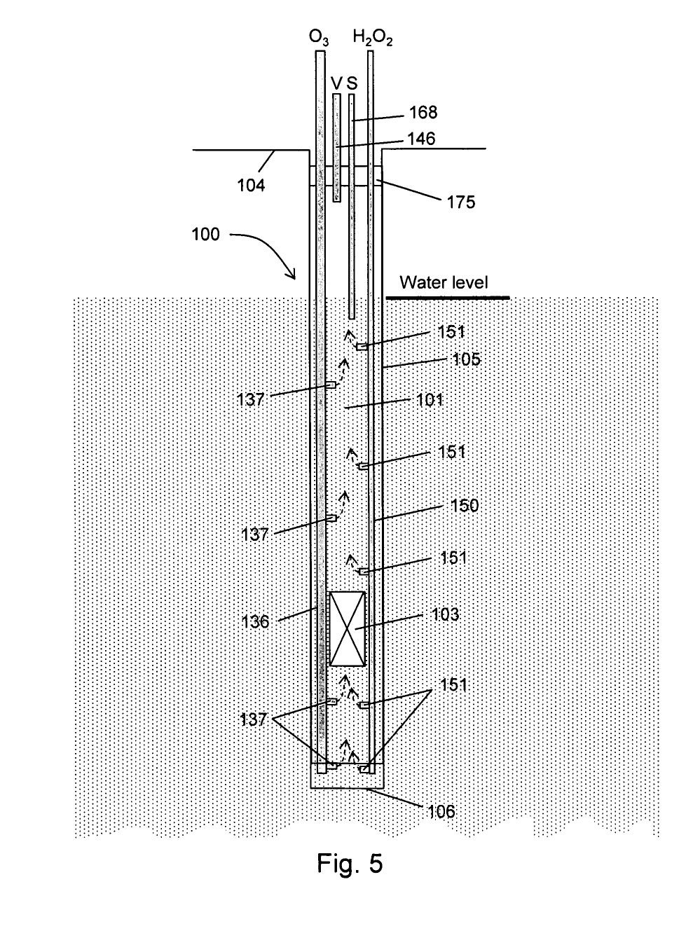

Another aspect of the present device, system, and method is direct in situ oxidation, which involves the direct injection of oxidants into a well or opening (also referred to as a bore hole), without the use of a reactor (identified by numeral 3 in previous drawings). An exemplary direct in situ system 100 is illustrated in FIG. 5. System 100 includes a well or opening 105 having a surface (or ground) level 104 and, in this case, a bottom 106.

An ozone (or oxygen or air) supply 136 with one or more injectors 137 is provided in the well or opening 105 for distributing the oxidant gas to the contaminated ground water 101 in the well or opening 105. Dotted lines with arrows indicate the flow of ozone into the contaminated water 101 in the well or opening 105, producing a zone of influence that destroys contaminants around the site of oxidant injection. As discussed above, gas lift causes contaminated water 101 to flow upward in the well or opening 105, typically with a reverse flow occurring at the periphery of the well or opening (i.e. along the walls). Since gas lift provides adequate circulation of the contaminated water, there is usually no need for a pump in the system 100. A liquid oxidant, such as H₂O₂, supply 150 with one or more injectors 151 is positioned in the well or opening 105 for distributing liquid oxidant to the contaminated ground water 101 in the well or opening 105. Dotted lines with arrows indicate the flow of H₂O₂ into the contaminated water 101.

The direct in situ oxidation system 100 shown in FIG. 5 includes a static mixer 103 to improve the distribution of oxidants in the ground water 101. The static mixer 103 may be placed at any location in the well or opening 105. Although not shown in all the figures, one or more static mixers 103 can be used in combination with any embodiment of the present apparatuses, devices, and methods. Exemplary types of static mixers 103 are of the vane-type and of the tab-type, although other designs may be used.

The direct in situ oxidation system 100 optionally includes a vent (V) 146, for releasing ozone (or other gas) pressure, and a sampling port (S) 168, for obtaining water 101 for analysis. A cap 175 may be provided to cover and/or seal the top of the well or opening 105.

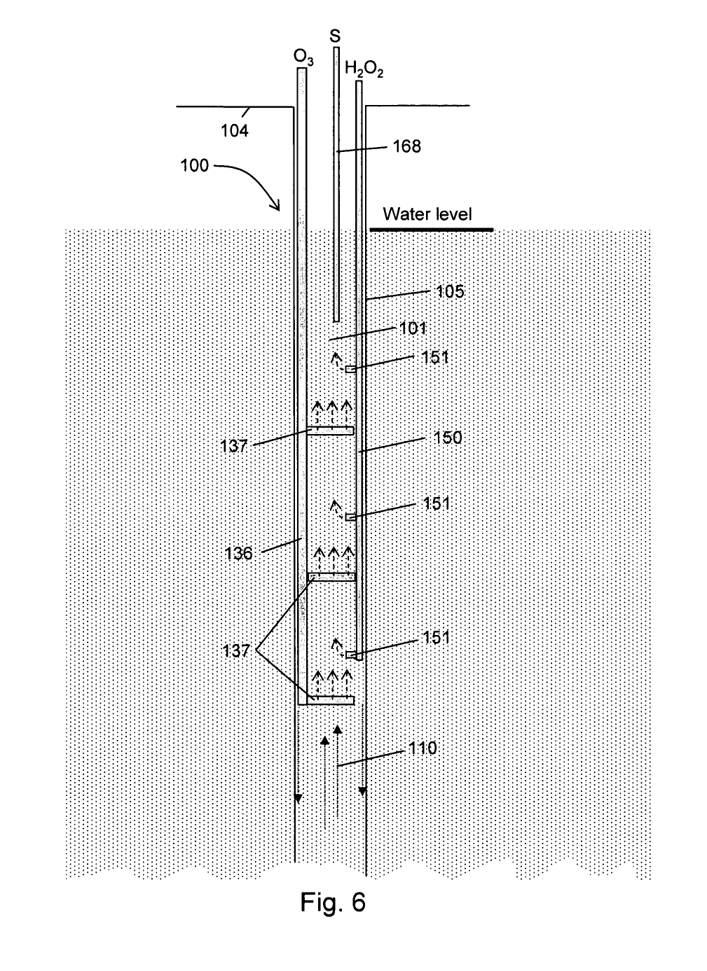

The direct system 100 illustrated in FIG. 6 is similar to that shown in FIG. 5 in having a well or opening 105 with a surface (or ground) level 104, an ozone supply 136 with one or more injectors 137, a hydrogen peroxide supply 150 with one or more injectors 151, and an optional sampling port (S) 168. In this case, the ozone or air injectors 137 provide a more even distribution of gas to the water 101 in the well or opening 105. Also in this example, the well or opening 105 is essentially “bottomless,” in that no part or component of the system 100 is in proximity with the bottom of the well opening 106, which may be of any depth. The vertical arrows 110 below the injectors 137, 151 indicate the direction of water 101 flow induced by gas rise, even below the components of the system 100.

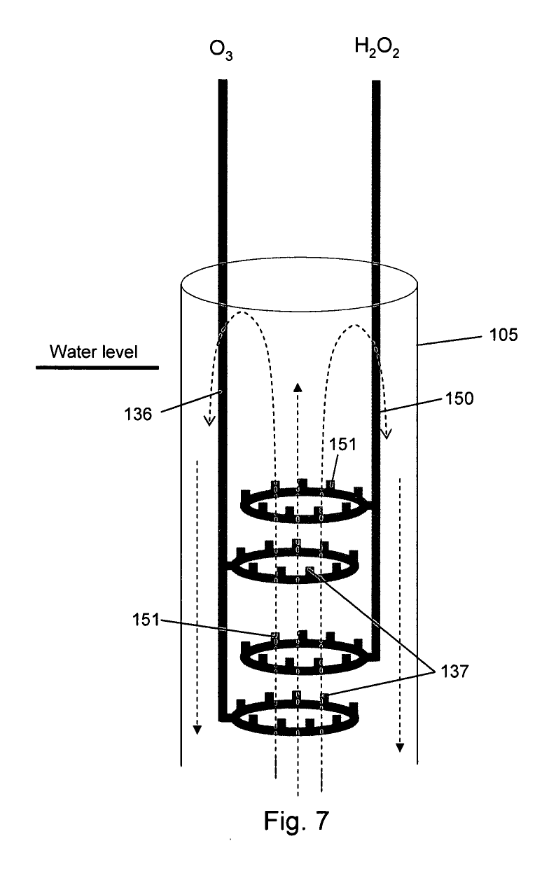

FIG. 7 illustrates a typical injector configuration for installation in a well or opening 105. The gas oxidant port/conduit 136 and injectors 137 and hydrogen peroxide port/conduit 150 and injectors 151 are indicated. The dotted lines with arrows indicate the direction of water flow caused by gas lift, which eliminates the need for a pump. Note that similar gas and liquid oxidant injector configuration may be use inside the reactors of other embodiments of the present systems and methods.

All gas and liquid oxidant injectors and sample ports may be fitted with a filter 97 to prevent the influx of soil and other particulate contaminants into air and liquid supplies and conduits. An exemplary filter 97 includes slotted gratings 98, as shown in FIGS. 4A and 4B. The embodiment shown in FIG. 4B includes a pointed end 160 that can be used to penetrate soil, while the slotted gratings 98 prevents the influx of soil and other particulate contaminants. In this manner, a conduit terminated with pointed slotted gratings 98, 160 can be used to penetrate the soil at the site of contamination, eliminating the need for a well or opening 5, as described for other embodiments. This form of the apparatus and method is known as direct penetration in situ oxidation, and can be used where there is no well or opening 5 in which to place a reactor 3 or a direct in situ oxidation apparatus, as described, above.

As shown in FIG. 4C, the slotted gratings 98 may be of a smaller diameter than the conduit 162 used to deliver an oxidant. In one method for direct penetration in situ advanced, high pressure oxidation, a hole is drilled in the soil, having a diameter approximately equal to a conduit 162 for delivering an oxidant. A conduit 62 terminated with pointed slotted gratings 98, 160 (FIG. 4C) is then inserted into the hole, wherein the smaller diameter of the slotted grating 98 ensures adequate flow of the oxidant (FIG. 4D) in the hole 164 (dotted arrows). As shown in FIG. 4E, multiple slotted gratings 98 may be present in a conduit 162 used to deliver an oxidant. Such conduits 162 may also be placed underground in a substantially horizontally configuration, such by drilling horizontally and inserting the conduit 162 or digging a trench and laying the conduit 162 in the trench below the ground 4, as shown in FIG. 4F.

### III. Configurations for Remediating Contaminated Sites

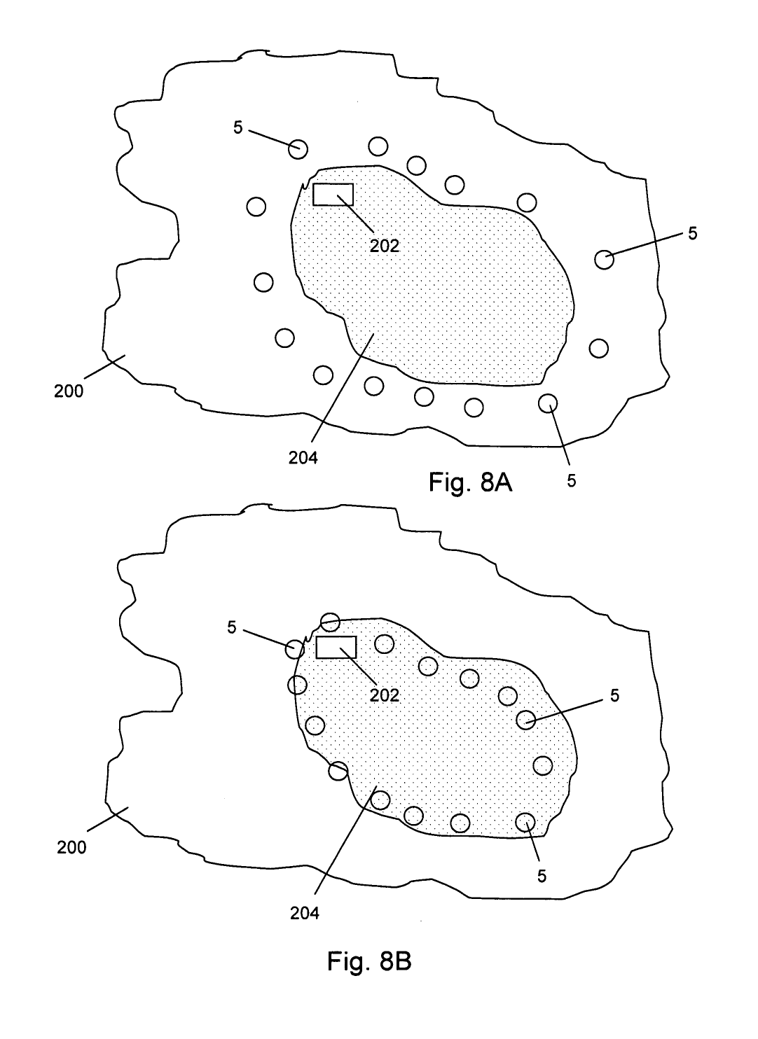

FIGS. 8A and 8B illustrate further embodiments of the apparatuses and methods that include a plurality of in situ oxidation systems distributed in different wells or openings 5 at a site of contamination 200. In these examples, a leaking underground storage tank (UST) 202 is responsible for a plume 204 of contamination at the site 200.

In the configuration shown in FIG. 8A, a plurality of in situ or direct in situ apparatus reactors (not shown) are installed in a series (or ring) of wells or openings 5 that substantially encompass the plume 204, thereby containing and focusing treatment on the affected area. In the configuration shown in FIG. 8B, a plurality of reactors (not shown) are installed in a series (or ring) of wells or openings 5 substantially within the plume 204, thereby focusing treatment on the affected area.

In preferred embodiments, the zones of influence of the individual reactors (or direct injection devices/systems) overlaps, such that soil and groundwater between the reactors/direct injection devices is subject to decontaminantion.

### IV. Advantages of In Situ Oxidation for Water Treatment

The use of in situ advanced, high pressure oxidation devices, systems, and methods for reclaiming contaminated water in a ground table offers several advantages over conventional advanced, high pressure oxidation methods and conventional in situ water treatment methods. For example, in addition to oxidizing contaminants immediately upon contact with the oxidants (i.e., ozone and hydrogen peroxide), residual oxidants present in decontaminated effluent water are distributed into the water in the well or opening, becoming available to oxidize further contaminants present in the water or surrounding soil. Moreover, the exchange and mixing of decontaminated water with contaminated water in the surrounding soil facilitates the gradual decontamination of an entire water table, including the soil, rocks, and/or other geographical features.

In some embodiments, decontaminated water can be discharged above ground/surface level, allowing the decontaminated water with residual oxidants to wash through the soil from above, speeding the process of reclaiming the water in the water table, and the associated geological formations. Moreover, discharged oxygenated ground water may support the growth of various organisms, which can also metabolize contaminants present ion the ground water.

In situ advanced, high pressure oxidation systems can be placed partially or substantially below the ground (i.e., subground, subterranean) minimizing the footprint of the systems. In some embodiments, a contaminated water table is provided with a number of in situ advanced, high pressure oxidation devices and systems in a number of wells or openings (e.g., 5, 10, 20, 100, or more), to increase the speed of decontamination. This arrangement is well suited for decontaminating toxic waste sites, chemical storage sites, landfills, chemical dumps, and the like. Where contaminants move in a plume, in situ devices and systems may be positioned to prevent the movement of the plume beyond a preselected geological location, serving as a barrier for the further contamination of water and/or soil in the water table. In this manner, in situ devices, systems, and methods may be deployed in the even of toxic spill or leak into ground water.

Note that all configurations that utilize a reactor 3 for delivering at least a gas oxidant to a well or opening 5 are herein referred to as “single point injection” apparatus, even if a plurality of injectors are present within the reactor. Single point injection make installation of the present apparatuses straightforward, and avoids the need to install a plurality of gas oxidant conduits and injectors in a well or opening 5. Reactor 3 can also be designed to provide a desired amount of mixing (e.g., based on the manner of injection of oxidants and/or the presence of a static mixer), thereby maximizing oxidant dissolution using single point injection.

Some embodiments of the apparatuses and methods rely on gas rise and do not require a pump for pumping contaminated water, thereby reducing energy consumption costs associated with site remediation.

### V. In Situ and Direct In Situ Advanced, High Pressure Oxidation for Mineral Recovery

In addition to being useful for water treatment, the present devices, systems, and methods can also be used for hydromining uranium and other ores. While these aspects of the devices, systems, and methods are discussed, below, it will be apparent that many of the features and variations discussed, above, also apply to mineral recovery.

A. Uranium Recovery

Uranium occurs mainly as uranium dioxide (i.e., urania or uranic oxide) in sedimentary rock, including sandstone, as well as in igneous and hydrothermal deposits. Because uranium is a rare element and present in relatively low amounts, uranium mining is a volume-intensive process, which favors open-pit mining, rather than sub-surface mining. In either case, large amounts of overburden, tailings, or other forms of soil and rock must be obtained from the site of a uranium deposit and further processed to recover uranium species, including elemental uranium and salts, thereof.

Uranium and other rare minerals are often extracted from soil and rock using the processes of “heap leaching,” in which a liquid (or mixed gas/liquid) chemical reagent is used to extract uranium (or other valuable materials) from piles (i.e., heaps) of material obtained from a mining site. Following percolation of the reagent through the heaps of material, reagent enriched with minerals is collected in a liner or basin for further processing. Exemplary reagents for use in heap leaching include acids and bases. In the case of uranium extraction, sulfuric acid is commonly used.

Uranium may also be extracted from soil and rock using the processes of “in-situ leaching” (also called “in-situ recovery” or “solution mining”), in which a liquid (or mixed gas/liquid) chemical reagent is introduced to the site of a subterranean deposit, and reagent enriched with valuable materials is subsequently recovered. The virgin reagent is typically introduced at a first injection well and the enriched reagent is extracted through a second well, thereby providing sufficient gradient movement and residence time to allow the reagent to leach minerals from the deposit. Exemplary reagents for use in heap leaching include acids and bases. In the case of uranium extraction, sulfuric acid is commonly used.

The present devices, systems, and methods are well suited for recovering uranium species from subsurface deposits by introducing oxidants (as described herein) into materials containing uranium and recovering oxidants enriched for uranium. Where the uranium deposits are in the ground, the present devices, systems, and methods superficially resemble in-situ leaching but use oxidants rather than acids or bases. In addition, the recovered uranium species are uranium ions, rather than uranium salts or reduced metal.

The present devices, systems, and methods require only a single well for use for introducing oxidants and recovering uranium species, as opposed to a first well for injecting a reagent and a second well for extracting the reagent enriched for uranium species. The ability to use a single well is due, in part, to the “zone of influence” produced by in situ advanced, high pressure oxidation, as described, herein. Note that while introduction of oxidants and recovery of uranium species may occur in a single well, it may still be desirable to use a plurality of wells, each one functioning independently or having overlapping zones of influence, e.g., as in the case of configurations for remediating contaminated sites.

While the term “in situ” has been used herein to refer to devices, systems, and methods that are in the ground, e.g., in a natural state, a variation involves the “in situ” treatment of heaps of materials. In this case, in situ or direct injection of oxidants is used to extract uranium species from soils and rocks that have been removed from the ground but still exist in a raw state (i.e., ex situ). In this manner, in situ oxidant injection or direct in situ oxidant injection can be used in method similar to heap leaching but offering numerous advantages over conventional methods.

In particular, advantages of the present devices, systems, and methods over conventional in situ mineral extraction methods include: (i) reduced residence time, (ii) reduced requirement for gradient movement though a deposit site, (iii) use of a single well for introducing reagents and recovering uranium species, (iv) use of oxidants rather than acids or bases, and (v) at least 10-fold better recovery than existing methods.

B. Recovery of Other Minerals

The recovery of minerals has been exemplified using uranium, for which in situ methods are already in use. However, the present devices, systems, and methods are not limited to the recovery of a particular mineral, and may be used to recover, e.g., copper, iron, gold, silver, or aluminum, or combinations, thereof. As in the case of uranium recovery, the devices, systems, and methods use oxidants to extract mineral ions. Advantages over conventional in situ extraction methods include: (i) reduced residence time, (ii) reduced need for gradient movement though a deposit site, (iii) use of a single well for introducing reagents and recovering mineral species, and (iv) use of oxidants rather than acids or bases.

C. Exemplary Systems for Mineral Recovery

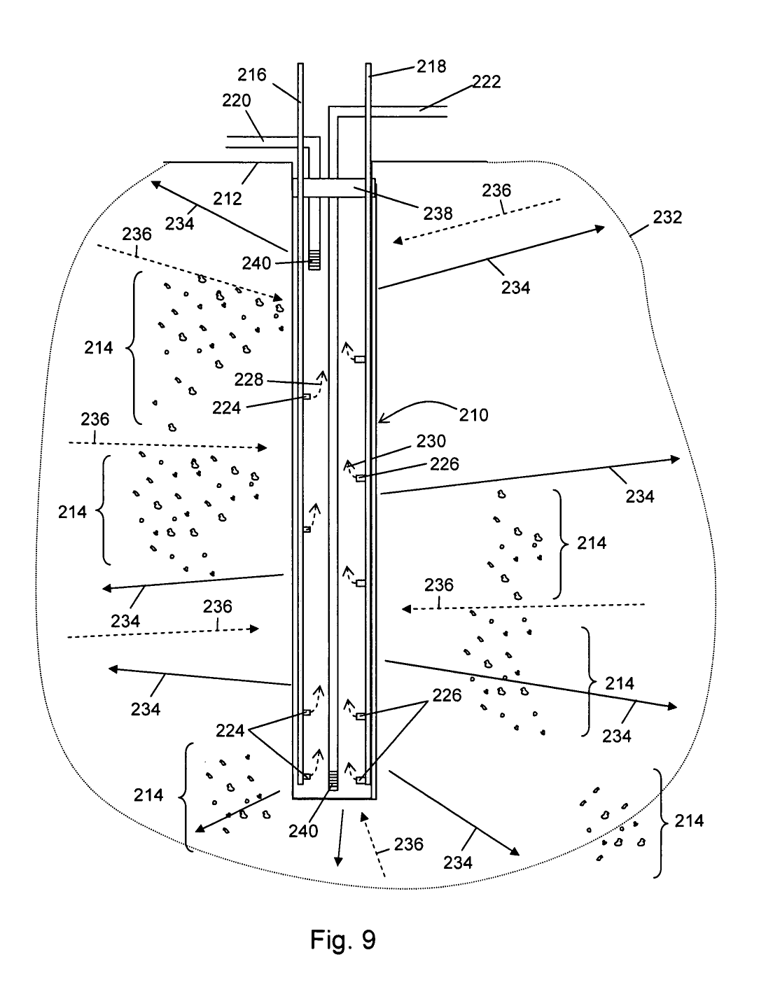

FIG. 9 shows a direct in situ advanced, high pressure oxidation system suitable for mineral recovery. A well or opening 210 below the surface 212 of soil or rock containing mineral deposits 214 includes a means for injecting hydrogen peroxide 216 and for injecting ozone or other gases 218, and optionally a means for injecting water 220 and a means for extracting water 222. Hydrogen peroxide injectors 224 and ozone or other gas injectors 226 are indicated, and associated curved dashed arrows indicate the flow of hydrogen peroxide 228 and ozone or other gases 230. As described herein, a zone of influence is created around the well or opening, as indicated by the dotted line 232. The solid arrows 234 indicate movement of oxidants away from the well or opening, while the dashed arrows 236 indicate movement of oxidants and recovered mineral ions back to the well or opening. The system shown in FIG. 9 includes a packer 238 and slotted gratings 240, as previously described.

It will be appreciated that the direct in situ system shown in FIG. 9 can be substituted by an in situ system that includes a reactor, e.g., as illustrated in FIG. 1. Where the well or opening adjacent to a mineral deposit is in a water table it may not be necessary to introduce water into the well or opening, since water is already present in the well. In such cases, it may only be necessary to extract water enriched for minerals, following oxidant injection. Where the well or opening is adjacent to a mineral deposit in dry soil or rock, it is generally necessary to introduce water (in addition to oxidants) into the well, and then extract water enriched for minerals from the well or opening. Where introduction of water into the well or opening is required, a pump-type system, rather than a gas rise system may be used.

As with the use of advanced, high pressure oxidation for water decontamination, a plurality of hydrogen peroxide injectors and ozone or other gas injectors may be used in the same well or opening, and/or a plurality of reactors (where present) can be used in the same well or opening. A plurality of similar systems may be placed in the ground at a site of a mineral deposit, and may have overlapping zones of influence. Where a plurality of similar systems are used, water can be introduced into one opening and water enriched for mineral ions can be extracted from another. Alternatively, water can be introduced, and water enriched for mineral ions can be extracted from the same well or opening. Also as described, herein, the wells or opening may be open or closed at the bottom.

### VI. In Situ and Direct In Situ Advanced, High Pressure Oxidation for Hydrocarbon Recovery

Ideal hydrocarbon/petroleum deposits exist under sufficient hydrostatic pressure to be forced out of a well drilled into the deposit without the need for pumps. However, when deposits are not under pressure, it is usually necessary to pump water, steam, or fracturing reagent into the deposit to displace the petroleum product or stimulate production. At some point, the cost of extraction exceeds the value of the deposit, resulting in exhausted strata that may still contain valuable hydrocarbons.

The present devices, systems, and methods can be used to stimulate production from strata previously thought to be exhausted or from which recovery using conventional methods is no longer economically viable. In addition to physically displacing the hydrocarbon with a gas and/or liquid oxidizing agent, the using of oxidants may stimulate the recovery via, e.g., catalytic cracking, wet oxidation, in situ oxidation, gasification, and other hydrocarbon recovery methods that utilize oxidizing agents.

Advantages over conventional hydrocarbon recovery methods include: (i) reduced residence time, (ii) reduced need for gradient movement though a deposit site, (iii) use of a single well for introducing reagents and recovering hydrocarbons, and (iv) use of oxidants rather than conventional fracturing agents.

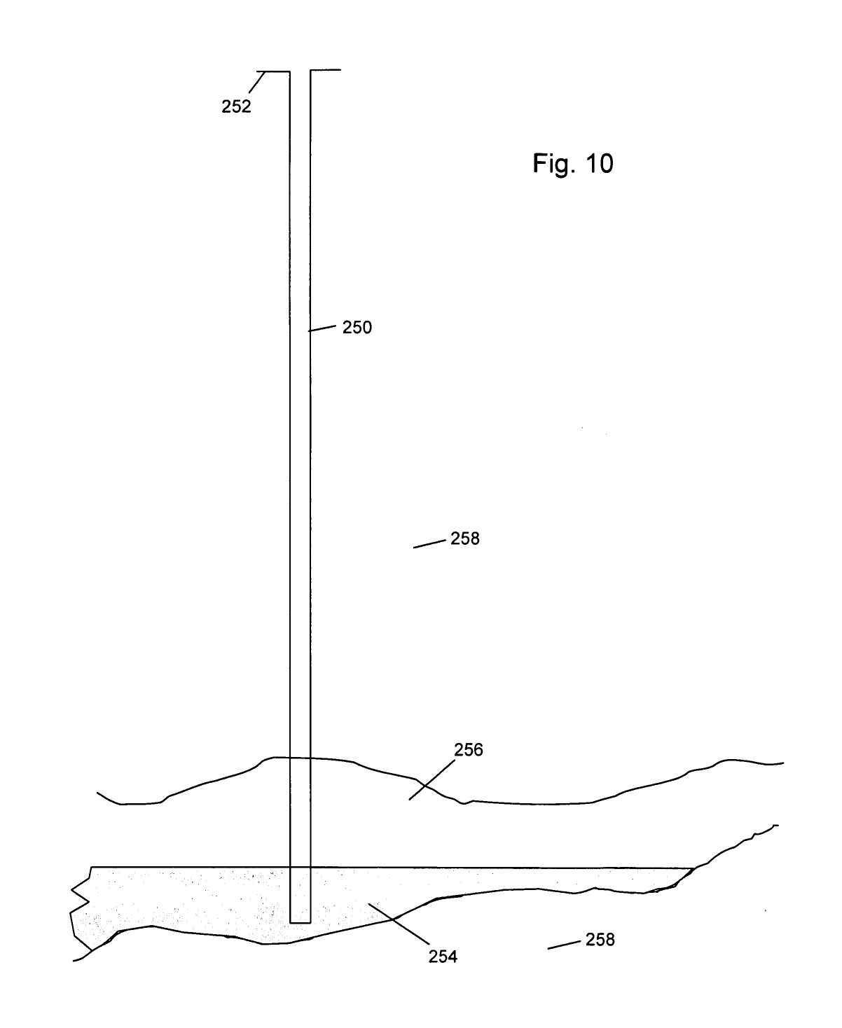

FIG. 10 shows a direct in situ advanced, high pressure oxidation system suitable for hydrocarbon recovery. A well or opening 250 below the surface 252 of soil or rock above a hydrocarbon deposit 254 is shown. The exemplary deposit is in a space 256 between layers of rock 258. Injection of hydrogen peroxide and or gas oxidants, optionally in combination with water, stimulates the deposit to produce hydrocarbons as described, above.

As above, a plurality of hydrogen peroxide injector and ozone or other gas injectors may be used in the same well or opening, and/or a plurality of reactors (where present) can be used. A plurality of similar systems may be placed in the ground above a hydrocarbon deposit, and may have overlapping zones of influence. Where a plurality of similar systems are used, oxidants (and water) can be introduced into one opening and hydrocarbons can be recovered from another. Alternatively, oxidants/water can be introduced, and hydrocarbons can be recovered from the same well or opening.

### VII. Selection of Oxidants

With respect to water treatment, advanced, high pressure oxidation (HiPOx™) involves oxidation of organic contaminants under pressure using the oxidants ozone and hydrogen peroxide (H₂O₂) or ozone alone. The advanced, high pressure oxidation process requires only seconds for efficient contaminant removal, thus prolonged residence time in a advanced, high pressure oxidation reactor is not required for complete decontamination. Advanced, high pressure oxidation treatment is effective in removing a variety of organic compound contaminants from water, including endocrine disrupting compounds (EDCs), pharmaceutically active compounds (PhaCs), and pathogens, such as Cryptosporidium, poliovirus, and coliforms. HiPOx™ is particularly effective in removing organic compounds such as nonylphenol (NP), triclosan (TCS), Bisphenol-A (BPA), estradiol equivalents (EEC)), and N-nitrosodimethylamine (NDMA).

Variations on the advanced, high pressure oxidation process utilize ozone, oxygen, oxygen-enriched air, ozone/oxygen, air, ozone/air, oxygen/air, or ozone/oxygen/air, which are collectively referred to as gas oxidants or oxidizing gasses. Such gas oxidants may be used in combination with a liquid oxidant, such as hydrogen peroxide. Any of these oxidant gas/hydrogen peroxide combinations can be used with any of the embodiments described herein, although the use of ozone and hydrogen peroxide is exemplified in some of the descriptions and drawing.

In some embodiments, an inert gas, such as helium, nitrogen, argon, or xenon is used in place of, or in addition to, an oxidant gas, e.g., to promote dissolution or mixing. An acid gas, such as such as carbon dioxide may be included to alter the pH of the influent water. Gases (including but not limited to oxidant gases) may be periodically or continuously added to a liquid oxidant to improve mixing or increase penetration into soil.

The selection of oxidants for use in the present methods largely depends on the contaminants present in the ground water and the proposed use or further processing of the decontaminated water. An excess of ozone may be used, such that residual ozone present in the decontaminated water is available to interact with additional contaminants present water or soil in or around a well or opening in a water table. Excess hydrogen peroxide may be used where bromate formation is an issue. An excess of both ozone and hydrogen peroxide may be used to maximize downstream decontamination by residual oxidants.

Alternatively, only hydrogen peroxide may be used at the oxidant, with air or oxygen replacing ozone. Air or oxygen may also be injected along with ozone, to improve the distribution of oxidants in the water or soil to be decontaminated. Since the level of residual oxygen present in decontaminated water determines the flora or microorganisms that will subsequently grow in the water, the oxygen dose can be tailored to accommodate aerobic or anaerobic organisms. The levels of oxidizing agents may also be adjusted to minimize the precipitation of iron and other minerals (i.e., plugging), which occurs in the presence of excess oxygen.

With respect to mineral recovery, the present devices, systems, and methods may utilize a liquid oxidant, such as hydrogen peroxide, optionally in combination with ozone, oxygen, or air, or mixtures, thereof. An inert gas, such as helium, nitrogen, argon, or xenon may be used in place of, or in addition to an oxidant gas, e.g., to promote dissolution or mixing.

With respect to hydrocarbon recovery, the present devices, systems, and methods may utilize a liquid oxidant, such as hydrogen peroxide and/or a gas oxidant, such as ozone, oxygen, or air, or combinations thereof. An inert gas, such as helium, nitrogen, argon, or xenon may be used in place of, or in addition to an oxidant gas, e.g., to promote dissolution or mixing or control in situ combustion.

### VIII. Business Methods

With respect to water treatment, the present methods include business methods based on the cost effective reclamation of ground water in a water table using the described devices, systems, and methods. The business methods comprise remediating contaminated ground water in a water table in situ for a client and charging the client a fee basing on the value of the remediated water. The value of the water may be the cost of replacing the water, the cost of disposing of the water, or the value of the water to a third party. The client may be and industry or a municipality. In some cases, the contaminated ground water is a fresh water source for a community. In some cases the contaminated ground water may be associated with a toxic waste site or chemical storage area.

With respect to mineral recovery, the present methods include business methods based on the cost effective reclamation of uranium and other mineral using in situ methods, including variations involving heap extraction. The business methods may involve obtaining the mineral at a cost less than that required using conventional methods, or savings in the clean up cost or environmental impact of mineral recovery compared to conventional methods.

With respect to hydrocarbon recovery, the present methods include business methods based on the cost effective reclamation of hydrocarbons using in situ methods, particularly as they pertain to recovering hydrocarbons from strata considered exhausted using conventional methods. The business methods may involve obtaining hydrocarbons at a cost less than that required using conventional methods, savings in the clean up cost or environmental impact of hydrocarbon recovery compared to conventional methods, or the ability to profitably use fields or wells thought to be exhausted using conventional methods.

### IX. Example

To facilitate a better understanding of the present systems and methods, the following example of certain aspects of some embodiments are given. In no way should the following example be read to limit, or define, the scope of the systems and methods.

Two wells were provided at a site in Eastern California known to be contaminated with benzene and methyl tertiary butyl ether (MTBE). An in situ advanced, high pressure oxidation reactor system sold under the name HiPOx® was installed into each of the two wells. The reactors had an outer diameter of 1 inch and the wells had a diameter of 2 inches. The reactors were injected alternately (pulsed operation) and the system operated for a period of about 5.5 weeks.

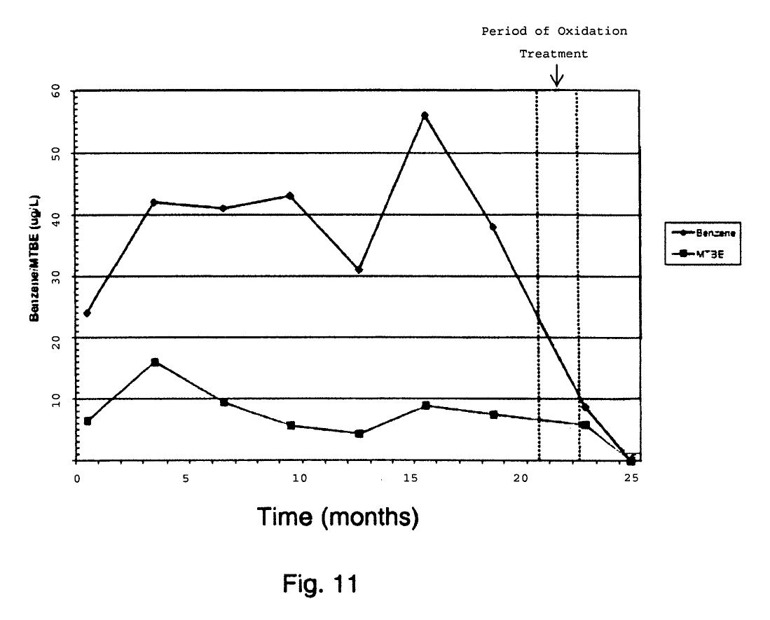

FIG. 11 is a graph illustrating the history of ground water contamination of benzene and MTBE at the site beginning approximately two years prior to installing the in situ reactors. The data shows that the amount of benzene and MTBE present at the site after treatment was below detection. These results demonstrate that the methods and systems of the present system can reduce the levels of ground water contamination effectively.

These and other applications and implementations will be apparent in view of the disclosure. Such modifications, substitutions and alternatives can be made without departing from the spirit and scope of the invention, which should be determined from the appended claims. While the present device, system, and method have been described with reference to several embodiments and uses, and several drawings, it will be appreciated that features and variations illustrated or described with respect to different embodiments, uses, and drawings can be combined in a single embodiment.

1. A method for in situ reduction of the concentration of a contaminant in ground water at a contamination site, comprising:
transporting contaminated ground water into a reactor, via an influent port of said reactor, wherein said reactor is positioned in an opening at ground level which extends below the water table at the contamination site, said influent port is positioned below the water table, and said reactor further has an effluent port;
introducing a gaseous oxidant into the contaminated water in the reactor;
introducing a liquid oxidant into said opening; and
continuing to introduce the gaseous oxidant and the liquid oxidant, to produce effluent water reduced in said contaminant

2. The method of claim 1, wherein said effluent water is discharged from the effluent port back into said opening, into a second well or opening, or above ground, such that said effluent water reenters the soil at said contamination site.

3. The method of claim 3, wherein said effluent water contains residual oxidant.

4. The method of claim 1, wherein the reactor represents a single point of delivery for the gaseous oxidant into the contaminated water.

5. The method of claim 1, wherein the liquid oxidant is introduced into the reactor.

6. The method of claim 1, wherein the liquid oxidant is introduced into said opening, external to the reactor.

7. The method of claim 5, wherein the reactor represents a single point of delivery for the gaseous oxidant and the liquid oxidant into the reactor.

8. The method of claim 1, wherein contaminated water is supplied to the influent port by means of a pump positioned above the reactor.

9. The method of claim 8, wherein said pump is within the opening.

10. The method of claim 1, wherein contaminated water is supplied to the influent port by means of a pump positioned below the reactor.

11. The method of claim 1, wherein the contaminated ground water is transported into the reactor as a result of gas lift caused by the rise of gas introduced into the reactor.

12. The method of claim 2, wherein said effluent water is discharged from the effluent port back into said opening.

13. The method of claim 2, wherein said effluent water is discharged from the effluent port into a second well or opening.

14. The method of claim 2, wherein said effluent water is discharged above ground.

15. The method of claim 1, wherein the gaseous oxidant is selected from the group consisting of ozone, oxygen, oxygen-enriched air, and mixtures thereof.

16. The method of claim 1, wherein the gaseous oxidant comprises ozone, air and ozone, or oxygen and ozone.

17. The method of claim 1, wherein the liquid oxidant comprises hydrogen peroxide.

18. An in situ system for decontaminating ground water in a water table at a contamination site, comprising:
a device adapted for placement in an opening at ground level which extends below the water table at the contamination site, the device having an influent port at a level below the water table and an effluent port;
means for providing contaminated ground water to the influent port of the device; and
conduits effective to deliver a liquid oxidant and a gaseous oxidant into said opening for contacting the contaminated ground water.

19. The system of claim 18, wherein said effluent port is effective to discharge effluent water back into said opening, into a second well or opening, or above ground, such that said effluent water reenters the soil at said contamination site.

20. The system of claim 18, wherein the means for providing contaminated ground water to the influent port is a pump.

21. The system of claim 18, wherein the means for providing contaminated ground water to the influent port is gas rise caused by the introduction of the gaseous oxidant into the reactor.

22. The system of claim 18, wherein the effluent port is at a level above the level of the influent port.

23. A system for decontaminating ground water in a water table, comprising:
at least one bore hole in the soil adjacent a water table; and
a conduit disposed within each said bore hole, said conduit having at least one filter, comprising a slotted grating arranged in-line with said conduit and having a diameter less than the diameter of said conduit, wherein when said conduit is positioned in said bore hole, each said filter is positioned below the level of water in the water table and functions as a point of egress for an oxidant into the soil of the water table.

24. The system of claim 23, wherein said conduit is terminated with one such filter which includes a pointed end for penetrating the soil.

25. The system of claim 23, wherein said conduit comprises multiple filters along its length.

26. A method for recovering minerals from a subterranean deposit, comprising:
forming a heap pile of material mined from a subterranean deposit;
providing a well or opening in the heap pile;
introducing into the well or opening a liquid oxidant and a gas oxidant selected from the group consisting of ozone, oxygen, and air, wherein the gas and liquid oxidants leach dissolved mineral ions from the heap pile; and
recovering oxidants enriched with dissolved mineral ions from the heap pile, thereby recovering minerals from the subterranean deposit.

27. The method of claim 26, wherein the mineral is uranium.

28. The method of claim 26, wherein the mineral is selected from the group consisting of copper, iron, gold, solver, and aluminum.

29. A method for recovering hydrocarbons from a subterranean deposit, comprising:
providing a well or opening having an opening at ground level above the level of the deposit, the well or opening having walls and a bottom in fluid or gas communication with the deposit;
introducing into the well or opening a liquid oxidant and a gas oxidant selected from the group consisting of ozone, oxygen, and air, wherein the gas and liquid oxidants stimulate release of the hydrocarbon from the deposit; and
recovering hydrocarbons from the well or opening, thereby recovering hydrocarbons from the subterranean deposit.

30. The method of claim 29, further comprising introducing water or steam into the well or opening.

31. The method of claim 29, wherein the hydrocarbon is crude oil or natural gas.
